(19) United States
(12) Patent Application Publication
(10) Pub. No.: US 2023/0281574 A1
(43) Pub. Date: Sep. 7, 2023

(54) SYSTEMS AND RELATED METHODS FOR THE DESIGN OF PLASTIC RECYCLING FACILITIES

(71) Applicant: KELLOGG BROWN & ROOT LLC, Houston, TX (US)

(72) Inventors: David John Cole, Houston, TX (US); Aron Dominic Pain, Houston, TX (US); William Ferrier, Houston, TX (US)

(73) Assignee: KELLOGG BROWN & ROOT LLC, Houston, TX (US)

(21) Appl. No.: 18/177,095

(22) Filed: Mar. 1, 2023

Related U.S. Application Data
(60) Provisional application No. 63/315,418, filed on Mar. 1, 2022.

(51) Int. Cl. G06Q 10/30; G06Q 30/018; G06Q 30/0283

(52) U.S. Cl. CPC G06Q 10/30; G06Q 30/018; G06Q 30/0283

(57) ABSTRACT

A method of designing a plastic recycling facility at a selected site includes representing each selected component of the plastic recycling facility a module defined by information relating to at least one of a carbon emission or a cost. The method also includes storing the information represented each module in a database accessible by a processor; programming the processor with a set of engineering rules, wherein each engineering rule is configured to represent a predetermined design decision relating to at least a design of the plastic recycling facility; and generating deliverables using at least the set of engineering rules and the modules. The deliverables may include at least: a cost estimate for the plastic recycling facility, and a carbon emission estimate for the plastic recycling facility.

### CROSS-REFERENCE TO RELATED APPLICATIONS

This application claims the benefit of U.S. Provisional Application No. 63/315,418, filed Mar. 1, 2022, which is incorporated herein by reference in its entirety.

### TECHNICAL FIELD

The present disclosure relates to devices and methods for designing and constructing plastic recycling facilities.

### BACKGROUND

Among the challenges posed by transitioning away from fossil fuels is the need to extend the capability to recycle plastic rather than rely on proceeding to create new plastic. Over the last several decades, the increased reliance on plastic has resulted in plastic becoming a rapidly growing segment of municipal solid waste. In 2018, the US generated 35.7 million tons of new plastic yet only 8.7 million tons were recycled with 27 million tons received into landfill. Because of the massive demand for plastic worldwide, there needs to be a method to design and optimize plastic recycling facilities quickly and efficiently.

### SUMMARY

The present disclosure describes systems and related methods for the design of plastic recycling facilities. In examples, the systems and methods described herein address the needs as well as other needs of the existing prior art.

In examples, disclosed is a method of designing a plastic recycling facility at a selected site. The method may include representing each selected component or engineering block of the plastic recycling facility with a module, each module being defined by information relating to at least one of a carbon emission or a cost; storing the information represented each module in a database accessible by a processor; programming the processor with a set of engineering rules, wherein each engineering rule is configured to represent a predetermined design decision relating to at least a design of the plastic recycling facility; and generating deliverables using at least the set of engineering rules and the modules. The deliverables may include at least: a cost estimate for the plastic recycling facility, and a carbon emission estimate for the plastic recycling facility.

In examples, described is a system for designing a plastic recycling facility at a selected site. The system may include a database configured to store a plurality of modules, wherein each module represents a selected component or engineering block of the plastic recycling facility, wherein each module is defined by information relating to at least one of a carbon emission or a cost; a processor programmed with a set of engineering rules, wherein each engineering rule is configured to represent a predetermined design decision relating to at least a design of the plastic recycling facility, wherein the database is accessible by the processor, and wherein the processor is configured to generate deliverables using at least the set of engineering rules and the modules. The generated deliverables may include at least: a cost estimate for the plastic recycling facility, and a carbon emission estimate for the plastic recycling facility.

Features of the disclosure have been summarized rather broadly in order that the detailed description thereof that follows may be better understood, and in order that the contributions to the art may be appreciated. Additional features of the disclosure may be present that are described hereinafter and which will in some cases form the subject of the claims appended thereto.

### BRIEF DESCRIPTION OF THE DRAWINGS

For detailed understanding of the present disclosure, references should be made to the following detailed description taken in conjunction with the accompanying drawings, in which like elements have been given like numerals and wherein:

FIG. 1 schematically illustrates a system for designing facilities for recycling plastic according to one embodiment of the present disclosure;

FIG. 2 illustrates a flowchart depicting a method for designing a facility for recycling plastic according to one embodiment of the present disclosure;

FIG. 3 illustrates a module used to perform a method for designing a facility for recycling plastic according to one embodiment of the present disclosure;

FIG. 4 illustrates a 3D plan generated by a method for designing facilities for recycling plastic according to one embodiment of the present disclosure; and

FIG. 5 illustrates a flowchart depicting a method for utilizing the FIG. 3 module to evaluate a design of a facility for recycling plastic according to one embodiment of the present disclosure.

### DETAILED DESCRIPTION

In examples, the present disclosure provides systems and related methods for generating a design for a plastic recycling facility. In examples, the generated design may include sufficient information to evaluate the technical and financial feasibility for a given project. For example, the engineering design may include the automated generation of drawings, engineering calculations, and a detailed material take off (MTO). As used herein, an MTO refers to a list of materials that are required to build a structure. The generated MTO may interface with a cost database to provide a cost estimate for the project. The cost database may include the price for materials, labor costs, and other cost-related information that may be used to estimate a complete project cost. In addition to quantities, grades, types, the MTO may include other information such as weight and other information that can be used to assess how to transport, store, install, or otherwise handle items on the MTO. Further, the MTO may include information relating to carbon emissions, embodied and/or operational, for the listed materials. Such information may be used to estimate a carbon emissions of the total design. The present disclosure is susceptible to embodiments of different forms. There are shown in the drawings, and herein will be described in detail, specific embodiments of the present disclosure with the understanding that the present disclosure is to be considered an exemplification of the principles of the disclosure and is not intended to limit the disclosure to that illustrated and described herein.

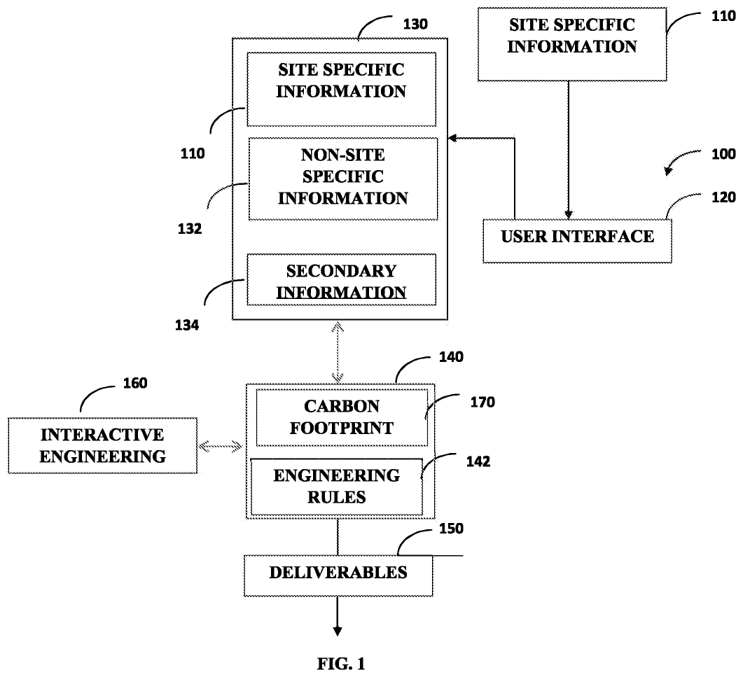

Referring to FIG. 1, there is illustrated a non-limiting embodiment of a system 100 for evaluating and developing a prospective site for a plastic recycling facility. Generally, a user enters site-specific information 110 into a user interface 120. The site-specific information 110 may include details such as the physical attributes of the prospective site. The user interface 120 may be configured to communicate the entered information to a database 130. The database 130 may be one database or a plurality of discrete databases. The database 130 may be configured to store non site-specific information 132, the site-specific information 110, and secondary information 134 (collectively, ‘information 110, 132, and 134’).

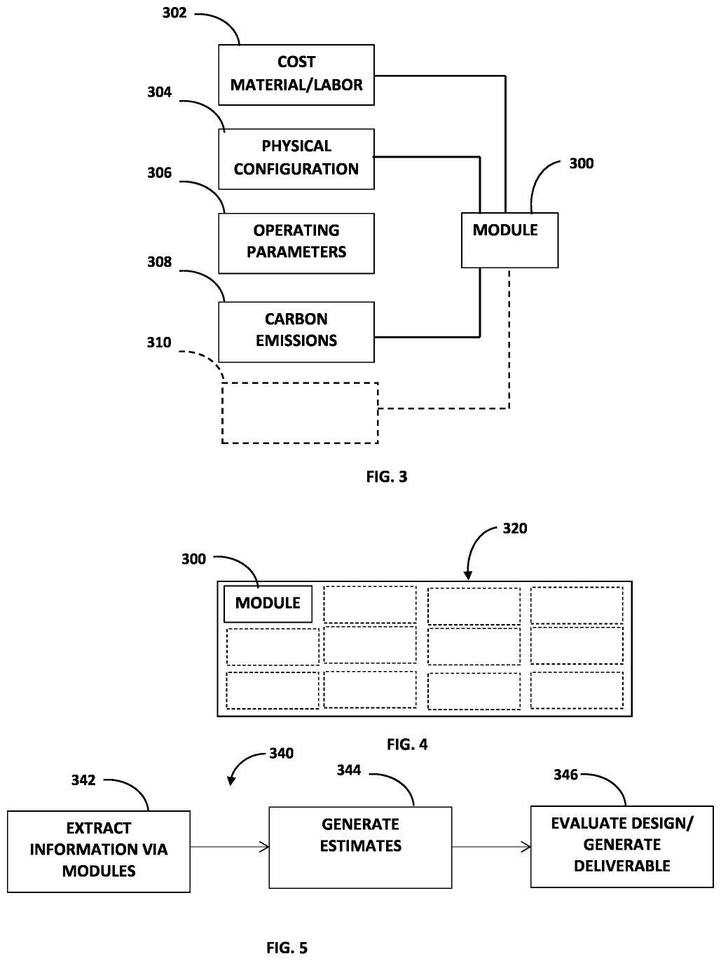

A processor 140 may be programmed with one or more engineering rules 142 and configured to interact with the database 130. The processor 140 may be a single processor or a plurality of co-located or distributed processors. In examples, the processor 140 processes the information 110, 132, and 134 using one or more of the engineering rules 142 to generate one or more deliverables 150. In examples, a deliverable 150 may be a body of information that enables the evaluation of one or more aspects of a design of a plastics recycling facility (e.g., cost, energy efficiency, carbon footprint, etc.). In further examples, a deliverable 150 may be a body of information used to construct and/or operate a plastics recycling facility. In examples, the interaction between the processor 140 and the database 130 may generate a deliverable in the form of a 3D plan 320 (FIG. 4) created using modules 300 (FIG. 3) in a manner described below. In examples, interactive engineering 160 may be used improve one or more aspects of the design of the plastics recycling facility (e.g., cost, energy efficiency, carbon footprint, etc.). Interactive engineering 160 may include human review of a generated deliverable and human initiated revision of one or more aspects of that deliverable or another deliverable. In examples, interactive engineering 160 may be accomplished via a user interface configured to allow a user to input revisions and/or modifications to the design or components thereof. In examples, interactive engineering 160 input instructions may be implemented and/or incorporated into the design and/or executed in a similar way as for the described engineering rules, information, modules, or any combinations thereof.

As will be appreciated from the discussion below, utilizing engineering rules 142 in conjunction with the non site-specific information 132 may enable the analyses and designs performed for one site to be re-used, at least to some degree, in the analyses and designs for subsequent sites. In examples, the information accumulated in the database 130 may include information relating to one or more previous or concurrent projects. Thus, by comparing information from discrete and separate projects, base lines and references for design, construction, and operation aspects, such as cost, efficiency, carbon emissions, construction times, etc., may be developed.

The site-specific information 110 may include information that is relevant to the engineering design of a plastic recycling facility and may also include other considerations such as overall costs and operational carbon emissions of the facility. As used herein, the term “site-specific” means information that physically defines the prospective site, specifies desired features of the plastic recycling facility, and/or the desired operational characteristics of the plastics recycling facility. In examples, information that physically defines the plastic recycling facility may include information obtained during a site survey during which personnel measure features, take visual images, evaluate above and below ground conditions, etc. The site-specific information 110 may also be obtained using public and/or private databases. For example, by using GPS coordinates, information regarding terrain, topography, and roadways may be obtained. In examples, desired features of the plastics recycling facility may include, firefighting and safety features, lighting, CCTV, external connectivity, etc. In examples, the desired operational features of the plastic recycling facility, e.g., type of plastic, throughput of plastic, etc. may also be entered into the system.

In examples, non-site specific information 132 may include information that relates to the equipment and materials used to construct a plastic recycling facility. For example, the non-site specific information 132 may include specifications, dimensions of components, availability of components, and costs for equipment, cabling, etc. As used herein, non-site specific information is information that may be relevant to the design and/or construction of two or more sites. By way of example, GPS coordinates will be unique to each site; i.e., site specific. The dimensions and costs of equipment may be the same or similar across two or more sites and thus non-site specific.

Secondary information 134 may include information that is user inputted but not site-specific information 110. For example, local constraints, such as space or regulations, may require alteration of equipment in some manner. Technical details such as the configuration, operation, and intended use of altered equipment may be added as secondary information to assist with equipment selection and design. In examples, secondary information may include information that relates to specific client requirements specifying design criteria or standards the client desires to apply in a country or region in which the site is located.

In examples, the site-specific information 110, the non-site specific information 132, and/or secondary information 134 may be entered and/or uploaded into the system 100. In examples, information may be entered into system 100 via interface 120. In examples, interface 120 may be a user interface. In examples, user interface 120 may be configured as a website front end. Any suitable interfacing computing equipment such as keyboard, touchscreen, mouse, scanner, microphone, camera, or other input device may be used to interact with user interface 120. In examples, user interface 120 may be implemented as a questionnaire or other fillable form. Other formats may also be used. In examples, user interface 120 may be configured to receive the information via upload as a computer file and/or via transmission such as download or other transmission. Information may be received at user interface 120 from physical memories such as USB drives and/or form cloud storage. Communication may be wired and/or wirelessly. In examples, the system 100 may be equipped with or coupled to a wireless transmitter that can receive and/or send information via a network, cellular, radio or other wireless means of communication. In examples, user interface 120 may be configured to transmit the entered information to the database 130. In examples, database 130 may be a memory that can either reside on a computing machine or may be a cloud database. In examples, database 130 may store the information 110, 132, and 134.

A processor 140 may be programmed with engineering rules 142 that may be configured to implement the predetermined design decisions for a selected site and thereby generate the deliverables 150. In examples, an engineering rule 142 may represent, correlate, and/or reflect a predetermined design decision governing the desired operational capabilities of the plastics recycling facility, acceptable location, spacing, and other placement criteria for equipment, desired safety and ergonomic criteria, and other structural and operation requirements for the plastics recycling facility. In examples, the processor 140 may retrieve from the database 130 the relevant stored information 110, 132, and 134. Thereafter, the processor 140 applies one or more of the engineering rules 142 to the retrieved information 110, 132, and 134. Illustrative, but not exhaustive, examples of predetermined design decisions may include identifying the throughput of plastic to be recycled per annum, identifying the type of plastic, sizing of the design permitted in the facility, locating fire detection panels and communication panels, identifying available pipe routes, etc.

In examples, an engineering rule 142 may be defined using mathematical relationships. For example, a rule to assign the size of equipment may be expressed as follows: (i) if the diameter of the equipment increases then increase the size of the supporting structure by the proportion specified in the rules to ensure the minimum human accessibility is maintained, (ii) if equipment and structure increase impacts neighboring structures then move these structures by the same proportion, and (iii) adjust the piping and cabling sizing and arrangements to maintain the design integrity. In examples, safety design rules may be included as part of engineering rules 142 to ensure the appropriate safety design requirements for a given jurisdiction are applied.

In examples, the engineering rules 142 may be encoded in a design software such as for example a computer-aided-design (CAD) program. Any suitable design software may be employed. In examples, the design software may be configured to generate 3D models. Examples of commercially available software solutions include, but are not limited to, AVEVA E3D, Hexagon Integraph Smart 3D, AutoDesk, and MicroStation. In examples, by encoding engineering rules 142 into a 3D design software, the system 100 may be able to output a 3D plan as at least a part of the deliverable 150. In examples, the deliverable 150 may be provided such that renditions of the plan or sub-components thereof may be extracted from the overall design plan.

In examples, human input, or interactive engineering 160, may be used for certain design aspects. In aspects, interactive engineering 160 includes human revision of a machine generated output. For example, the processor 140 may generate a 3D plan 320 (FIG. 4) wherein one or more of the modules 300 (FIG. 3) may represent, model, embody, describe, and/or characterize an engineering block or component of a facility. For example, based on the engineering rules 142 processor 140 may select the locations for engineering blocks or facility components based on a standard site layout. A human user may then want to adjust the location, or other aspect, of the engineering blocks to improve site access, layout, and safety egress. As will be described later, the module 300 representing, modeling, embodying, describing, and/or characterizing an engineering block or component of a facility may be associated with information for cost and carbon emissions in addition to physical configuration. Thus, in examples, system 100 may allow a user to modify or supplement site-specific information 110, non-site specific information 132, and/or secondary information 134 to affect the deliverable 150. In examples, in response to the additional input, the processor 140 may update deliverables 150 for overall design, cost and carbon footprint taking into account the added or modified information. Thus, interactive engineering 160 may be considered as a set of inputs that reflect an interaction between a human user and the processor 140 to identify opportunities to revise layouts to achieve an optimized design both commercially and technically.

In examples, a carbon footprint engineering 170 may be performed by processor 140 based on the engineering rules 142 using the information 110, 132, and 134. Illustrative, but not exhaustive, examples of engineering rules 142 related to carbon emission include: identifying the quantity of equipment, identifying metallurgy, assigning logistical arrangements, specifying construction site locations, identifying fabrication methods, etc. The engineering rules 142 directed to these activities may be configured to assign carbon emission values for such activities and generate an estimated carbon footprint for the plastics recycling facility design. In examples, carbon footprint engineering 170 may be performed using a separate carbon emission calculation software with which system 100 can be configured to interact. As described previously, a human user may revise one or more aspects of the plastics recycling facility design based on the estimated carbon footprint by adding or modifying any of the uploaded information 110, 132, and/or 134. Thus, via the interactive engineering 160, system 100 can provide engineering designs that have a desired features such as, for example, overall carbon footprint below a certain limit.

In examples, the processor 140 may generate the deliverables 150 using the information 110, 132, 134, the engineering rules 142, the interactive engineering 160, and the carbon footprint engineering 170. In examples, the deliverables 150 for the completion of the detailed design process for each plastic recycling facility may include, but not be limited to, Material Take Off (MTO), center of gravity calculations, construction drawings, overall layout drawing, cost estimate, 2D drawing, and 3D plan in a commercially available software. Generally, a 3D plan is a three-dimensional visual representation of a physical design. Other deliverables may include, but are not limited to general arrangement drawings and plot plans etc. In examples, the deliverables 150 may also include the assessment and calculation of the carbon footprint impact of each plastic recycling facility.

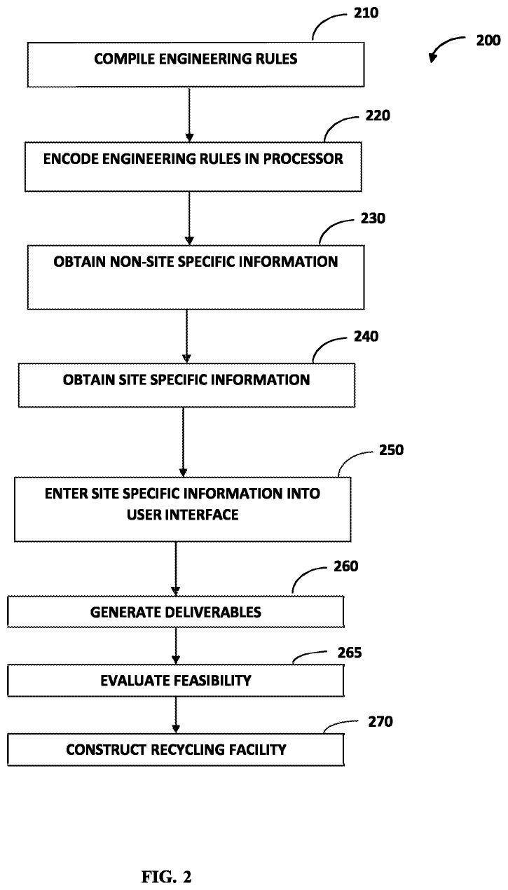

Referring to FIG. 2, there is shown a non-limiting embodiment of a method 200 according to the present disclosure for efficiently evaluating, optimizing and developing a prospective site for a plastic recycling facility.

Referring to FIGS. 1 and 2, at 210, a set of engineering rules 142 may be configured using conventional programming techniques. Each engineering rule may represent and/or reflect a predetermined design decision that has generic application across two or more sites. As noted previously, these engineering rules 142 may embodiment regulatory requirements, conventional engineering practices, etc. At 220, the engineering rules 142 may be programmed into a processor 140. In examples, the processor 140 may be a general-purpose computer that runs commercially available engineering software. At 230, non-site specific information 132 is loaded into and stored in the database 130. This information, which may include costs and specifications, may be received from equipment suppliers, construction companies, and other entities that may participate in the construction of the plastic recycling facility at the selected site. At 240, a user may obtain site specific information 110 for the selected site. This information may be obtained during a physical inspection of the selected site and also from public and/or private databases. At 250, the site specific information 110 may be entered via a user interface 120 into the database 130. At 260, the processor 140 generates the deliverables 150 based on the non-site specific information 132, the site specific information 110 and secondary information 134 and applying the engineering rules 142. In examples, processor 140 may also determine carbon footprint by performing the carbon footprint engineering 170. In examples, the deliverables 150 may be generated to a level of detail that may either support the evaluation and determination of the feasibility of a plastic recycling facility at 265. In examples, if the design is found acceptable, then at 270, to deliverables may be output for the construction of the plastic recycling facility. At 270, the deliverables may be used to construct a plastic recycling facility. In examples, the steps of the method 200 may be reordered as needed to suit a particular situation. For example, the site-specific information 110 may be collected first. Thereafter, the type and quantity of the non-site-specific information 132 may be identified and collected. Moreover, the information in the database 130 and/or the engineering rules 142 in the processor 140 may be periodically or continuously updated.

Referring to FIG. 3, there is shown in block diagram format, an example of a module 300 that may be used in conjunction with the FIG. 2 method to generate a 3D plan 420 (FIG. 4) for a plastics recycling facility. Generally, a module 300 is a collection of data that may represent, model, embody, describe, and/or characterize a selected engineering block or selected component of the plastics recycling facility. In examples, a module 300 may be a collection of information that defines an engineering block or component of the plastics recycling facility with respect to, without limitation, physical dimensions, weight, power consumption, cost, carbon emissions, service life, maintenance schedule, lifting/handling requirements, HVAC requirements, etc. In examples, a module 300 may include a cost definition 302, which may include material cost and associated labor, a physical definition 304, which may include size, shape, weight, operation definition 306, which may include rated capacity, power demands, service life, a carbon emissions definition 308, which may include embodied and operational carbon emissions, and secondary definitions 310, which may vary site-to-site. By engineering block or component, it is meant a device, structure, wiring, cabling, machine, sub-system, or system. In examples, not every engineering block or component of the plastics recycling facility needs to be represented, modeled, embodied, described, and/or characterized by a module 300. Rather, only the components or engineering blocks considered desirable to obtain an estimate of a selected aspect of the plastics recycling facility with a desired accuracy may be selected to be represented, modeled, embodied, described, and/or characterized by a module.

In embodiments, the information defining the module 300 may be used by the processor 140 (FIG. 1) to generate some or all of a deliverable 150 (FIG. 1), such as a 3D plan. Referring to FIG. 4, there is shown an exemplary 3D plan 320 of a plastics recycling facility that may be generated using modules 300 of FIG. 3. In examples, the processor 140 (FIG. 1) may use the engineering rules 142 (FIG. 1) and the information 110, 132, and 134 to select and organize modules 300 to meet specified requirements (e.g., space, operating capacity, power demands, etc.). For simplicity, the modules 300 are shown as rectangular blocks. As discussed previously in connection with FIG. 1, based on the engineering rules 142 and information 110, 132, and 134, the processor 140 may identify a preliminary placement of the modules 300 based on a standard site layout. That is, based on the engineering rules 142 and information 110, 132, and 134, processor 140 may process the definitions 302-310, select components having the desired physical configuration and operating parameters, and construct a preliminary 3D plan 320. In examples, the processor 140 (FIG. 1) may generate on a suitable display (not shown) a 3D plan wherein the modules 300 may be depicted by visual images of the various components or engineering blocks they represent in the plastics recycling facility. Human operators may then adjust the 3D plan 320 through interactive engineering 160. In examples, the adjustments may be based on considerations such as site access, layout, and safety egress. In examples, the adjustments may be made dynamically. For example, processor 140 (FIG. 1) may provide immediate feedback if a proposed adjustment is not possible due to space constraints or incompatible equipment.

Referring to FIG. 5, there is shown one non-limiting method 340 for generating one or more deliverables using the modules 300 of FIG. 3. By example, a deliverable 150 (FIG. 1) may be an estimate of the embodied and operational carbon emissions of a proposed plastics recycling facility. At 342, the processor 140 (FIG. 1) may extract the carbon emissions information for each of the modules 300 making up the 3D plan 320 (FIG. 4) and at 344 may calculate the estimated carbon emissions for the proposed recycling plant. In examples, at 344 system 100 may estimate carbon emissions for the proposed recycling plant at least based on the system generated MTO. At 346, the design may be evaluated, and the deliverable generated. In examples, a carbon emission limit may be entered as any of information 110, 132, or 134. In examples, the entered carbon emission limit may be compared with the estimated carbon emission calculated at 344. In examples, at 346, the estimated carbon emissions from 344 may be found to be unacceptable, for example, exceeding the entered carbon emission limit. In examples, if the estimated carbon emissions are found to be unacceptable the system may be configured to iteratively process different design options based on engineering rules 142, and information 110, 132, and 134 to achieve, if feasible, a deliverable 150 that meets the entered carbon emission limit and/or to identify potential engineering blocks or components or configurations that may be revised to lower the estimated carbon emissions. For example, if the number or type of valves used in a design are predicted to generate an undesirable amount of gas leakage, a different valve configuration may be used. In another example, if a particular structure is predicted to produce an undesirable amount of carbon during fabrication, a different construction or a different structure may be used.

In another example, a deliverable 150 (FIG. 1) may be an estimate of the complete cost of constructing the proposed plastics recycling facility. At 342, the processor 140 (FIG. 1) may extract the cost definition 302 (FIG. 3) for each of the modules 300 (FIG. 3) making up the 3D plan 320 (FIG. 4) and at 344 calculate the estimated overall cost of the proposed recycling plant, including materials and labor. At 346, the design may be evaluated, and the deliverable generated. In examples, a cost limit may be entered as any of information 110, 132, or 134. In examples, the entered cost limit may be compared with the estimated overall cost calculated at 344. In examples, at 344 system 100 may estimate overall cost for the proposed recycling plant at least based on the system generated MTO. In examples, at 346, the estimated overall cost from 344 may be found to be unacceptable, for example, exceeding the entered cost limit. In examples, if the estimated overall cost is found to be unacceptable the system may be configured to iteratively process different design options based on engineering rules 142, and information 110, 132, and 134 to achieve, if feasible, a deliverable 150 that meets the entered cost limit and/or to identify potential engineering blocks or components or configurations that may be revised to lower the estimated overall cost.

In examples, one or more limits may be entered in combination or in the alternative. In examples, a user may require that either a cost limit or a carbon emission limit be met. In examples, a user may require that both a cost limit and a carbon emission limit be met. In examples, a user may require additional and/or different limitations or requirements to a deliverable in the same manner as described with respect to carbon emission limits and cost limit.

In examples, although not shown, the one or more systems may include one or more controllers and/or other suitable computing devices may be employed to operate one or more of portions of system 100 described herein. Controllers and/or other computing devices may include one or more processors and memory communicatively coupled with each other. In the illustrated example, a memory may be used to store logic instructions to operate and/or control operation of system 100. In examples, the controllers and/or other computing devices may include or be coupled to input/output devices such as monitors, keyboards, speakers, microphones, computer mouse and the like. In examples, the one or more controllers and/or other computing devices may also include one or more communication components such as transceivers or like structure as described to enable wired and/or wireless communication. In examples, this may allow for remote operation of the system described herein.

In examples, memory associated with the one or more controllers and/or other suitable computing devices may be non-transitory computer-readable media. The memory may store an operating system and one or more software applications, instructions, programs, rules, and/or data to implement the methods described herein and the functions attributed to the system. In various implementations, the memory may be implemented using any suitable memory technology, such as static random-access memory (SRAM), synchronous dynamic RAM (SDRAM), nonvolatile/Flash-type memory, or any other type of memory capable of storing information. The system may include any number of logical, programmatic, and physical components.

Logic instructions may include one or more software packages. Any operation of the described system may be implemented in hardware, software, or a combination thereof. In the context of software, operations represent computer-executable instructions stored on one or more computer-readable storage media that, when executed by one or more processors, perform the recited operations. Generally, computer-executable instructions include routines, programs, objects, components, data structures, and the like that perform one or more functions or implement particular abstract data types.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure. It is intended that the following claims be interpreted to embrace all such modifications and changes.

What is claimed is:

1. A method of designing a plastic recycling facility at a selected site, comprising:
representing each select component of the plastic recycling facility with a module, wherein each module is defined by information relating to at least one of a carbon emission or a cost;
storing the information represented each module in a database accessible by a processor;
programming the processor with a set of engineering rules, wherein each engineering rule is configured to represent a predetermined design decision relating to at least a design of the plastic recycling facility; and
generating deliverables using at least the set of engineering rules and the modules, wherein the generated deliverables comprise:
a cost estimate for the plastic recycling facility, and
a carbon emission estimate for the plastic recycling facility.

2. The method of claim 1, further comprising:
obtaining site specific information for the selected site; and
conveying the site-specific information via a user interface to the database, wherein the site-specific information is also used to generate the deliverables.

3. The method of claim 1, wherein the information defining carbon emissions comprises embodied carbon emissions and operational carbon emissions.

4. The method of claim 1, wherein each module is further defined by information relating to at least one of a physical definition and an operating definition.

5. The method of claim 1, wherein the generated deliverables further comprise at least one additional deliverable selected from one of: a Material Take Off (MTO), a construction drawing, an overall layout drawing, a 2D drawing, and a 3D plan.

6. The method of claim 5, further comprising:
revising at least one generated deliverable, wherein the revising is performed by a human user.

7. The method of claim 6, wherein, based on the at least one revised deliverable, the processor is further configured to change at least one of:
the cost estimate for the plastic recycling facility, and
a carbon emission estimate for the plastic recycling facility.

8. The method of claim 6, wherein the processor is configured to update at least one additional deliverable based on the at least one revised deliverable.

9. A system for designing a plastic recycling facility at a selected site, comprising:
a database configured to store a plurality of modules, wherein each module represents a selected component of the plastic recycling facility, wherein each module is defined by information relating to at least one of a carbon emission or a cost; and
a processor programmed with a set of engineering rules, wherein each engineering rule is configured to represent a predetermined design decision relating to at least a design of the plastic recycling facility, wherein the database is accessible by the processor, and wherein the processor is configured to generate deliverables using at least the set of engineering rules and the modules, wherein the generated deliverables comprise:
a cost estimate for the plastic recycling facility, and
a carbon emission estimate for the plastic recycling facility.

10. The system of claim 9, the processor is further configured to generate the deliverables using site specific information.

11. The system of claim 9, wherein the information defining carbon emissions comprises embodied carbon emissions and operational carbon emissions.

12. The system of claim 9, wherein the associated module is further defined by information relating to at least one of a physical definition and an operating definition.

13. The system of claim 9, wherein the generated deliverables further comprise at least one additional deliverable selected from one of: a Material Take Off (MTO), a construction drawing, an overall layout drawing, a 2D drawing, and a 3D plan.

14. The system of claim 13, wherein the processor is further configured to revise at least one generated deliverable in response to interaction with a human user.

15. The system of claim 13, wherein the processor is further configured to update at least one additional deliverable based on the at least one revised deliverable.

16. A non-transitory computer readable medium having stored thereon a computer-executable code that, when executed by a processor, causes the processor to:
generate deliverables using at least a set of engineering rules and a plurality of modules, wherein the generated deliverables comprise:
a cost estimate for a plastic recycling facility, and
a carbon emission estimate for the plastic recycling facility,
wherein each module of the plurality of modules represents a selected component of the plastic recycling facility,
wherein each module is defined by information relating to at least one of a carbon emission or a cost, and
wherein each engineering rule of the set of engineering rules is configured to represent a predetermined design decision relating to at least a design of the plastic recycling facility.
